(19) United States
(12) Patent Application Publication
(10) Pub. No.: US 2015/0255084 A1
(43) Pub. Date: Sep. 10, 2015

(54) NOISE REDUCTION DEVICE

(71) Applicant: JVC KENWOOD Corporation, Yokohama-shi (JP)

(72) Inventors: Keisuke ODA, Yokohama-shi (JP); Takaaki YAMABE, Yokohama-shi (JP)

(21) Appl. No.: 14/641,020

(22) Filed: Mar. 6, 2015

(30) Foreign Application Priority Data
Mar. 7, 2014 (JP) 2014-044481

(51) Int. Cl. G10L 21/0208

(52) U.S. Cl. CPC G10L 21/0208

(57) ABSTRACT

A noise elimination device according to the present invention includes a periodic noise information storage unit 32 configured to accumulates an input signal including a periodic noise, and thereby stores noise history information which includes at least one cycle of the periodic noise in a non-voice section in which a voice signal component is equal to or lower than a predetermined voice threshold level, wherein the voice signal component is being a main component of an output signal, and a noise filter 35 that generates a suppression signal in which the periodic noise included in the input signal is reversed by using the noise history information as a reference signal, and generates the output signal So in which the periodic noise included in the input signal is suppressed by using the suppression signal.

### INCORPORATION BY REFERENCE

This application is based upon and claims the benefit of priority from Japanese patent application No. 2014-044481, filed on Mar. 7, 2014, the disclosure of which is incorporated herein in its entirety by reference.

### BACKGROUND OF THE INVENTION

1. Field of the Invention

The present invention relates to a noise reduction device, in particular, a noise reduction device that reduces a cyclic noise (also referred to as “periodic noise”).

2. Description of Related Art

In mobile communication devices, there is a problem that when a noise is mixed into a voice, which is the intended sound, due to surrounding environments, it is very difficult to obtain the voice. In radio devices, in particular, there is a periodic noise such as a siren that occurs, for example, when firefighters go to the site of a fire or when they fight against the fire at the site. When a radio device is used while a siren is wailing, the siren sound is mixed into a voice and picked up by the radio device, thus causing a problem that the person on the receiving side can hardly catch the voice. Therefore, Japanese Unexamined Patent Application Publications No. S60-033752, No. 2002-258899, No. 2000-293965, No. 2003-58186, No. 2002-367298, and No. H11-232802 disclose techniques for reducing noises.

Japanese Unexamined Patent Application Publication No. S60-033752 discloses a modified version of a speech processing method SPAC (Speech Processing system by use of an Auto correlation function). In the SPAC, a voice, which is the intended signal, can be emphasized by obtaining a short-time auto-correlation at an interval corresponding to one cycle of an input signal and connecting waveforms each corresponding to one cycle of the correlation function. However, although the ability of the SPAC to reduce random noises is high, the effect of the SPAC for periodic noises is poor because the SPAC has such a characteristic that periodic waveforms are emphasized. Therefore, Japanese Unexamined Patent Application Publication No. S60-033752 makes it possible to reduce the level of periodic noises as well as random noises by subtracting a waveform obtained by averaging short-time auto-correlation functions in the process in which a voice waveform is synthesized by connecting waveforms each corresponding to one cycle of the correlation function.

However, under the condition where background noises could be mixed into the voices as in the case of mobile communications, there are cases where one cycle cannot be accurately measured by the auto-correlation function. Therefore, in Japanese Unexamined Patent Application Publication No. S60-033752, there is a possibility that discontinuity between frames occurs in the process for synthesizing a voice waveform by connecting waveforms each corresponding to one cycle of the correlation function, thus causing pulse noises. Accordingly, the technique disclosed in Japanese Unexamined Patent Application Publication No. S60-033752 is not suitable for the use in which background noises could be mixed into the voices.

In Japanese Unexamined Patent Application Publication No. 2002-258899, an input signal in which a siren sound is mixed into a voice signal is converted from a time domain to a frequency domain for each frame having a predetermined time length, and the presence/absence of the siren sound is detected from the frequency domain signal. Then, in Japanese Unexamined Patent Application Publication No. 2002-258899, when a siren sound is present, the basic frequency of the siren sound is extracted and the siren sound is suppressed by suppressing a harmonics component(s) several times higher than the basic frequency. Note that in Japanese Unexamined Patent Application Publication No. 2002-258899, as a method for detecting a siren sound, firstly, a point at which the sum total of the spectra of each frequency and its harmonics is maximized is calculated as a basing frequency. Then, a root-mean-square error between the calculated basic frequency and a siren sound fundamental period pattern that is registered in a memory in advance is calculated. When the root-mean-square error is smaller than a predefined threshold, it is determined that a siren sound is present. On the other hand, when the root-mean-square error is larger than the predefined threshold, it is determined that there is no siren sound.

In Japanese Unexamined Patent Application Publication No. 2000-293965, means for sampling an assumed (or expected) mechanical noise signal(s) and storing the sampled noise signal as a pseudo-noise waveform(s) into a memory such as a nonvolatile memory in advance is provided. Then, the pseudo-noise is read from the nonvolatile memory at the noise pitch of a mechanical noise picked up by a microphone and the read pseudo-noise is subtracted from the input signal. By doing so, the noise is reduced.

In Japanese Unexamined Patent Application Publication No. 2003-58186, a siren sound suppression information setting unit detects the presence/absence of a noise to be suppressed from a signal that is converted into a frequency domain. Then, the noise's basic frequency is extracted and supplied to a siren sound suppression unit. Further, in Japanese Unexamined Patent Application Publication No. 2003-58186, this siren sound suppression unit suppresses a siren sound noise based on this information. In this case, the siren sound suppression unit extracts a basic frequency at an interval corresponding to a predetermined frame, so that the memory capacity necessary in a long-term average spectrum amplitude update unit can be reduced. Further, in Japanese Unexamined Patent Application Publication No. 2003-58186, an output of the siren sound suppression unit is supplied to a stationary noise suppression unit and a stationary noise is thereby suppressed.

Each of Japanese Unexamined Patent Application Publications No. 2002-367298 and No. H11-232802 discloses a technique in which a noise is reduce by generating a pseudo-noise signal having a correlation with a noise component mixed into an information signal by using an adaptive filter based on an energy wave generated by using energy generation means and then subtracting the pseudo-noise signal component from the information signal. Further, when the operating mode of an electronic device changes, the noise component of the information signal changes. Therefore, each of Japanese Unexamined Patent Application Publications No. 2002-367298 and No. H11-232802 also discloses a technique in which convergence speed of the noise cancelling is increased by changing a step gain in and near the operating mode transition period of the electronic device.

### SUMMARY OF THE INVENTION

However, the present inventors have found the following problem. The frequency changing speeds of periodic noises such as siren sounds differ from one another depending on the noise source or the region. In Japanese Unexamined Patent Application Publications No. 2002-258899, No. 2000-293965, No. 2003-58186, and No. 2002-367298, there is a problem that: in order to cope with a number of types of periodic noises, it is necessary to prepare information about a number of noise components corresponding to these types of periodic noises; however, it is very difficult to cope with every one of these periodic noises.

A first exemplary aspect of the present invention is a noise elimination device including: a periodic noise information storage unit configured to accumulates an input signal including a periodic noise, and thereby stores noise history information which includes at least one cycle of the periodic noise in a non-voice section in which a voice signal component is equal to or lower than a predetermined voice threshold level, wherein the voice signal component is being a main component of an output signal; and a noise filter that generates a suppression signal in which the periodic noise included in the input signal is reversed by using the noise history information as a reference signal, and generates the output signal in which the periodic noise included in the input signal is suppressed by using the suppression signal.

Another exemplary aspect of the present invention is a noise elimination method in a noise elimination device that suppresses a periodic noise included in an input signal and outputs an output signal, the noise elimination method including: accumulating the input signal, and thereby storing noise history information which includes at least one cycle of the periodic noise in a non-voice section in which a voice signal component is equal to or lower than a predetermined voice threshold level, wherein the voice signal component is being a main component of an output signal; and generating a suppression signal in which the periodic noise included in the input signal is reversed by using the noise history information as a reference signal, and generating the output signal by suppressing the periodic noise included in the input signal by using the suppression signal.

Another exemplary aspect of the present invention is a noise elimination program executed by an arithmetic unit in a noise elimination device, the noise elimination device including the arithmetic unit and a storage unit and being configured to suppress a periodic noise included in an input signal and output an output signal, the noise elimination program being adapted for causing a computer to execute: a periodic noise information storing step of accumulating the input signal including the periodic noise, and thereby storing noise history information which includes at least one cycle of the periodic noise in a non-voice section in which a voice signal component is equal to or lower than a predetermined voice threshold level, wherein the voice signal component is being a main component of the output signal; and a noise filter step of generating a suppression signal in which the periodic noise included in the input signal is reversed by using the noise history information as a reference signal, and generating the output signal in which the periodic noise included in the input signal is suppressed by using the suppression signal.

According to the present invention, a noise elimination device, a noise elimination method, and a noise elimination program capable of achieving a high noise suppression effect irrespective of the type of the periodic noise are provided.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram of a noise elimination device according to a first exemplary embodiment;

FIG. 2 is a block diagram of an adaptive filter unit according to the first exemplary embodiment;

FIG. 3 is a flowchart of a siren sound detection process performed by a noise elimination device according to the first exemplary embodiment;

FIG. 4 is a graph showing a first example of changes of an auto-correlation value over time in the noise elimination device according to the first exemplary embodiment;

FIG. 5 is a graph showing a second example of changes of an auto-correlation value over time in the noise elimination device according to the first exemplary embodiment;

FIG. 6 is a graph showing a third example of changes of an auto-correlation value over time in the noise elimination device according to the first exemplary embodiment;

FIG. 7 is a graph showing a fourth example of changes of an auto-correlation value over time in the noise elimination device according to the first exemplary embodiment;

FIG. 8 is a flowchart of a noise elimination process performed by the noise elimination device according to the first exemplary embodiment;

FIG. 9 is a graph for explaining an example of an input signal input to the noise elimination device according to the first exemplary embodiment;

FIGS. 10A and 10B show graphs showing a first example of frequency changes of a siren sound over time and signal level changes over frequencies; and

FIGS. 11A and 11B show graphs showing a second example of frequency changes of a siren sound over time and signal level changes over frequencies.

### DESCRIPTION OF THE EXEMPLARY EMBODIMENTS

### First Exemplary Embodiment

Exemplary embodiments according to the present invention are explained hereinafter with reference to the drawings. When a cyclic noise (also referred to as “periodic noise”) is mixed into an input signal, a noise elimination device 1 according to a first exemplary embodiment outputs an output signal that is obtained by suppressing the periodic noise from the input signal. Note that the periodic noise is a noise whose frequency periodically changes. For example, a siren sound generated by a fire engine or the like is considered to be a periodic noise. In the following explanation, an example in which a siren sound is used as a periodic noise is shown for simplifying the explanation. However, the periodic noise is not limited to siren sounds and includes various noises whose frequencies periodically change.

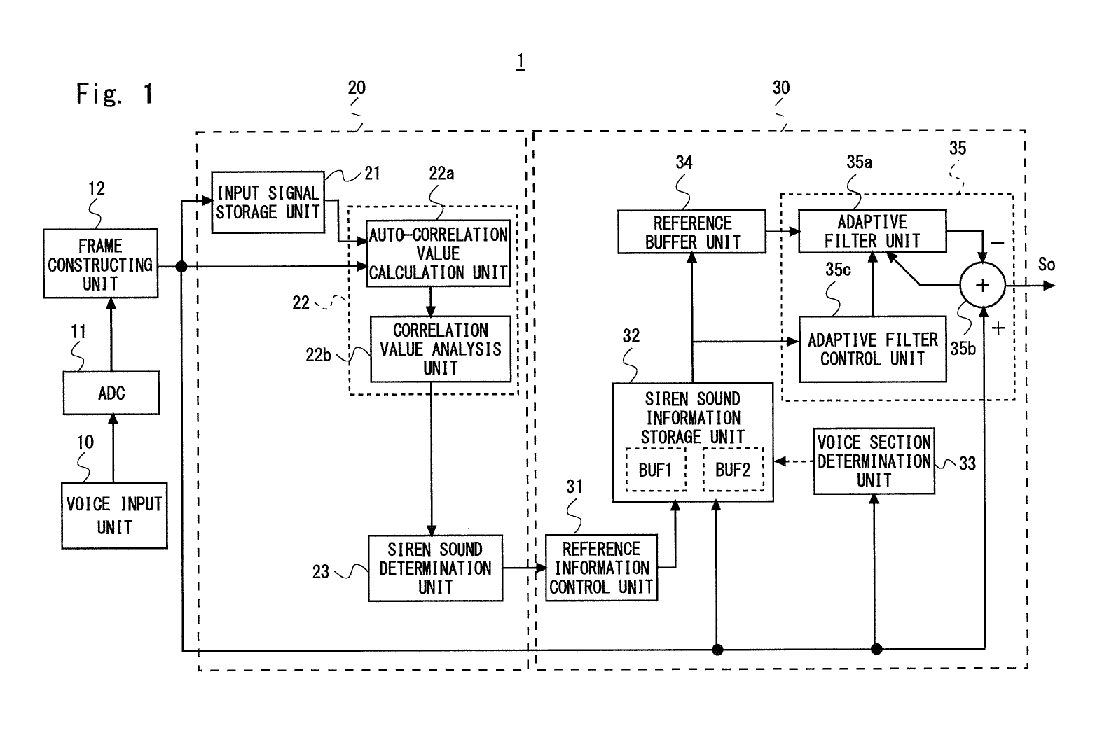

FIG. 1 is a block diagram of the noise elimination device 1 according to a first exemplary embodiment. As shown in FIG. 1, the noise elimination device 1 according to the first exemplary embodiment includes a voice input unit 10, an analog-digital converter 11, a frame constructing unit 12, a noise detection unit 20, and a noise suppression unit 30.

Note that in the noise elimination device 1, the voice input unit 10 and a storage unit for storing various information items may be constructed by hardware. Further, in the noise elimination device 1, processing performed for information or signals by the noise detection unit 20 and the noise suppression unit 30 may be implemented by a program(s) (e.g., a noise elimination program) that is executed by an arithmetic unit such as CPU (Central Processing Unit) or DSP (Digital Signal Processor). In this case, the noise elimination program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be supplied to a computer including a CPU through a wire communication path such as an electrical wire and an optical fiber, or wireless communication path. Further, each component implemented by a program may be constructed by hardware.

The voice input unit 10 is, for example, a sensor such as a microphone, and externally acquires a voice signal. The voice signal acquired by the voice input unit 10 is an analog signal. The analog-digital converter 11 converts the analog voice signal into a digital signal. The frame constructing unit 12 converts an input signal, which has been converted into a digital value, into frames in units that are determined according to the predefined number of samples. The noise detection unit 20 and the noise suppression unit 30 perform a periodic noise (e.g., siren sound) detection process and a noise elimination process for the input signal, which has been converted into the frames.

When the noise detection unit 20 detects that a periodic noise is included in the current input signal based on the correlation between the current input signal and a preceding input signal(s), which was input prior to the current input signal, the noise detection unit 20 outputs a periodic noise detection signal including cycle information of the periodic noise. More specifically, the noise detection unit 20 accumulates input signals as history information and thereby generates a preceding input signal(s), and determines the presence/absence of a siren sound and the cycle of the siren sound based on a correlation between the preceding signal(s) and the current input signal. Then, when the noise detection unit 20 determines that a siren sound is included in the input signal, the noise detection unit 20 sets a siren sound mode signal included in the periodic noise detection signal to a siren sound lock mode for instructing the noise suppression unit 30 to perform a siren sound elimination process, and outputs the cycle information of the siren sound to the noise suppression unit 30.

The noise detection unit 20 includes an input signal storage unit 21, an auto-correlation unit 22, and a periodic noise determination unit (e.g., siren sound determination unit 23). Further, the auto-correlation unit 22 includes an auto-correlation value calculation unit 22a and a correlation value analysis unit 22b.

The input signal storage unit 21 accumulates input signals and thereby generates a preceding input signal(s). The length of the preceding input signal held by the input signal storage unit 21 may be set to such a length that a time width necessary for obtaining the cyclic nature of a siren sound can be secured. That is, the input signal storage unit 21 adds a newly input input signal to the preceding input signal while discarding the information of the oldest input signal of the preceding input signals, and thereby continuously holds the information of an input signal(s) corresponding to the necessary time width as the information of the preceding input signal.

The auto-correlation unit 22 calculates an auto-correlation value between the current input signal and the preceding input signal, and analyzes the cycle information of an auto-correlation value larger than a predefined auto-correlation threshold. Note that the auto-correlation unit 22 calculates the auto-correlation value between the current input signal and the preceding input signal by using the auto-correlation value calculation unit 22a. Further, the correlation value analysis unit 22b accumulates auto-correlation values calculated in the auto-correlation value calculation unit 22a, analyzes the positions and the intervals of peaks of an auto-correlation value(s) larger than the auto-correlation threshold, and outputs the positions and the intervals of the peaks of the auto-correlation value(s) as cycle information of the siren sound. Note that for the auto-correlation threshold, a positive difference value from the average value of correlation values in a predetermined time width, a value obtained from a predetermined multiplying factor or the like with respect to the average value of correlation values, or the like can be used.

A calculation method for an auto-correlation value performed in the auto-correlation value calculation unit 22a is explained hereinafter. In the first exemplary embodiment, for example, the below-shown Expression (1) can be used as a calculation formula for the auto-correlation value.

$$\begin{matrix}[ Expression 1 ] & \\ A [ m ] = \frac{1}{N} {\sum }_{n = 0}^{N - 1} x [ n ] \cdot x [ n - m ] , m = 0 , 1 , … , N - 1 & ( 1 )\end{matrix}$$

In Expression (1), m and n are natural numbers. In particular, m is a value indicating a range (time width) in which an auto-correlation value is calculated from a series of input signals (hereinafter referred to as “input signal series”) and corresponds to a phase difference between the current input signal and an input signal included in the preceding input signal. Further, N is a constant corresponding to the maximum phase difference (search range), and n is the number of samples of an input signal series for which an auto-correlation value is calculated. Further, x is an input signal converted into a frame, and A[m] is an auto-correlation value in a phase difference m.

The siren sound determination unit 23 determines whether or not a periodic noise (e.g., siren sound) is included in the current input signal based on the cycle information. Then, when it is determined that a periodic noise is included in the current input signal, the siren sound determination unit 23 outputs the cycle information to a reference information control unit 31 of the noise suppression unit 30. The siren sound determination unit 23 makes the following decision when it determines whether or not a siren sound is included in the current input signal.

Firstly, the siren sound determination unit 23 determines whether or not there are peaks of an auto-correlation value (e.g., auto-correlation values equal to or larger than an auto-correlation threshold) at regular intervals by referring to the cycle information. Next, when it is determined that there are peaks of an auto-correlation value at regular intervals, the siren sound determination unit 23 determines there is a peak of other auto-correlation values between these peaks located at regular intervals (hereinafter referred to as “evenly-spaced peaks”). Next, when it is determined that there is no peak of other auto-correlation values between the evenly-spaced peaks of the auto-correlation value, the siren sound determination unit 23 determines whether or not the intervals between the evenly-spaced peaks of the correlation value are within a range of a siren cycle threshold that is assumed to be the cycle of a siren sound. Next, when it is determined that the intervals between the evenly-spaced peaks of the correlation value are within the range of the siren cycle threshold, the siren sound determination unit 23 determines the signal level. Then, when the determined signal level is larger than a siren sound level threshold, the siren sound determination unit 23 determines that a siren sound is included in the input signal and hence sets a siren sound mode signal to a siren sound lock mode.

Note that the siren sound determination unit 23 preferably sets the siren sound mode signal to the siren sound lock mode when the period during which it is determined that a siren sound is included in the input signal continues for a certain period or longer. This is because if the siren sound mode signal is immediately changed to the siren sound lock mode based on the determination result that a siren sound is included in the input signal, a false determination that could possibly occur in the siren sound determination process would affect the overall process of the noise elimination device.

Next, the noise suppression unit 30 is explained. The noise suppression unit 30 holds information corresponding to one cycle of a siren sound obtained from an input signal including no voice component, and generates a suppression signal in which the siren sound is reversed by using the held information corresponding to one cycle of the siren sound as a reference signal. Then, the noise suppression unit 30 subtracts the generated suppression signal from the input signal and thereby outputs an output signal So in which the siren sound is suppressed. As shown in FIG. 1, the noise suppression unit 30 includes a reference information control unit 31, a periodic noise information storage unit (e.g., siren sound information storage unit 32), a voice section determination unit 33, a reference buffer unit 34, and a noise filter 35.

The reference information control unit 31 indicates the range of noise history information that the siren sound information storage unit 32 should store and the cut-out position of noise history information that the siren sound information storage unit 32 should output based on the cycle information of the periodic noise output by the siren sound determination unit 23. This indication about the range of the noise history information includes information about the time width corresponding to one cycle of a siren sound and information about the cut-out position of the noise history information stored in the siren sound information storage unit 32.

The siren sound information storage unit 32 accumulates input signals including periodic noises, and thereby stores noise history information including information corresponding to at least one cycle of a periodic noise in a non-voice section in which a voice signal component, which is the main component of an output signal, is equal to or lower than a predefined voice threshold level. Further, the voice section determination unit 33 brings a voice section signal into an enabled state when a voice signal component included in the input signals is larger than the voice threshold level. That is, the voice section determination unit 33 analyzes a signal component(s) included in the input signals and thereby determines whether or not a voice signal component is included in the input signals. For this analysis method, for example, a method for determining a voice signal component based on a spectrum component(s) of an input signal disclosed in Japanese Unexamined Patent Application Publication No. 2012-128411, which has already been filed by the inventors of the present application, can be used.

The noise history information stored in the siren sound information storage unit 32 is explained hereinafter in a more detailed manner. The siren sound information storage unit 32 includes a first buffer unit BUF1 and a second buffer unit BUF2. Further, the siren sound information storage unit 32 constructs noise history information to be stored in the first buffer unit BUF1 and noise history information to be stored in the second buffer unit BUF2 from an input signal(s) of a frame(s) that is determined to be a non-voice section by the voice section determination unit 33.

In the first buffer unit BUF1, input signals are successively stored so that noise history information is generated. For the noise history information stored in the first buffer unit BUF1, old information is discarded every time a new input signal is input and the newly input input signal is added as the newest information. By doing so, the noise history information stored in the first buffer unit BUF1 is maintained in a fixed length. Meanwhile, the noise history information stored in the second buffer unit BUF2 is constructed by noise history information having a length corresponding to one cycle of a periodic noise in a non-voice section obtained from the noise history information stored in the first buffer unit BUF1.

Then, when the voice section signal is in a disabled state and noise history information corresponding to one cycle of a siren sound is stored in the first buffer unit BUF1, the siren sound information storage unit 32 outputs the noise history information stored in the first buffer unit BUF1. On the other hand, when the voice section signal is changed to an enabled state in the voice section determination unit 33, the siren sound information storage unit 32 initializes the noise history information stored in the first buffer unit BUF1 and outputs the noise history information stored in the second buffer unit BUF2. Further, in response to a situation where noise history information corresponding to one cycle of a periodic noise has been accumulated in the first buffer unit BUF1, the siren sound information storage unit 32 updates (i.e., overwrites) the noise history information stored in the second buffer unit BUF2 by the noise history information stored in the first buffer unit BUF1.

Note that the siren sound information storage unit 32 outputs continuity information that indicates whether the noise history information to be output is in a discontinuous state or not. A state of this continuity information becomes a disabled state to indicate that discontinuity has occurred in the noise history information when the storage source of the noise history information is changed. Then, when the noise history information is continuously output from the same storage source for a certain period or longer, the state of the continuity information becomes an enabled state.

The reference buffer unit 34 holds the noise history information output by the siren sound information storage unit 32 as a reference signal. Specifically, the reference buffer unit 34 temporarily stores the signal that the siren sound information storage unit 32 has output based on the cut-out position of the noise history information to be output indicated by the reference information control unit 31 as a reference signal.

The noise filter 35 generates a suppression signal in which the periodic noise included in the input signal is reversed based on the reference signal and then generates an output signal So in which the periodic noise included in the input signal is suppressed by using the suppression signal. More specifically, the noise filter 35 includes an adaptive filter unit 35a, an adder 35b, and an adaptive filter control unit 35c.

The adaptive filter control unit 35c is, for example, a filter circuit such as an FIR (Finite Impulse Response) filter. The adaptive filter unit 35a generates a suppression signal based on the reference signal. The adder 35b outputs a residual component between the suppression signal and the input signal as an output signal So. In this adder 35b, the suppression signal output from the adaptive filter unit 35a is input to its inverting input terminal. That is, the adder 35b substantially functions as a subtracter that subtracts the suppression signal component from the input signal. Further, the adder 35b also outputs the residual component, which is output as the output signal So, to the adaptive filter unit 35a. The adaptive filter unit 35a shapes the waveform of the suppression signal based on this residual component. More specifically, the adaptive filter unit 35a controls a filter coefficient(s) used inside the adaptive filter unit 35a based on the residual component so that the waveform of the suppression closely resembles that of the input signal. This adaptive filter unit 35a is a filter that converts a past input signal series, which is input as a reference signal, into a pseudo-input signal.

The adaptive filter control unit 35c outputs a filter control signal for increasing the convergence speed of the adaptive filter unit 35a in response to the change of the reference signal to a temporally discontinuous state. The signal stored in the reference buffer unit 34 is always updated by a past siren sound signal that was input one cycle ago when a siren sound is detected and it is in a non-voice section. The continuity of this siren sound signal is maintained and the filter coefficient of the adaptive filter unit 35a is also in a stable state. On the other hand, when the voice signal state has changed to a state where a siren sound is detected and it is determined to be in a voice section, the reference buffer unit 34 stores a signal series different from the immediately preceding siren sound signal (e.g., siren sound signal that was input one cycle ago) as a reference sound. (That is, the reference buffer unit 34 stores the noise history information of the second buffer unit BUF2 of the siren sound information storage unit as a reference sound). In this case, the continuity of the reference signal is lost. As a result, the difference value between the suppression signal generated in the adaptive filter and the input signal temporarily increases and hence the siren sound suppression effect is lowered. To prevent this phenomenon, the convergence speed (acceleration coefficient) is raised (increased) until the siren sound suppression level reaches a predetermined siren sound suppression level in the adaptive filter control unit 35c based on the continuity information output by the siren sound information storage unit 32 so that the siren sound suppression effect is maintained when the reference signal is switched.

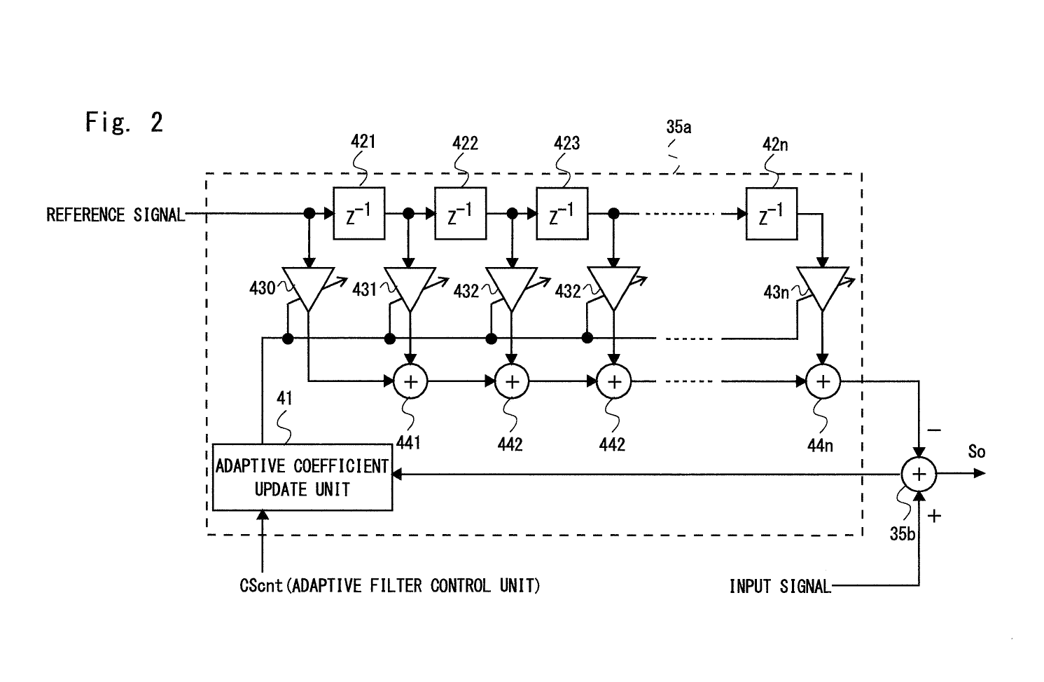

FIG. 2 shows an example of a block diagram of the adaptive filter unit 35a and the adaptive filter unit 35a is explained hereinafter in a more detailed manner with reference to FIG. 2. As shown in FIG. 2, the adaptive filter unit 35a includes an adaptive coefficient update unit 41, delay circuits 421 to 42n, variable gain amplifiers 430 to 43n, and adders 441 to 44n. Note that n is an integer indicating a component number.

The delay circuits 421 to 42n are connected in series. Further, the variable gain amplifier 430 amplifies a reference signal by a predetermined gain and outputs the amplified signal to the adder 441. The variable gain amplifiers 431 to 43n amplify the outputs of the delay circuits 421 to 42n by predetermined gains and output the amplified signals to the adders 441 to 44n. Each of the adders 442 to 44n adds the output of the preceding adder and a respective one of the variable gain amplifiers 432 to 43n. Then, the output of the adder 44n disposed at the last stage is used as the suppression signal.

The adaptive coefficient update unit 41 refers to a residual signal output by the adder 35b and thereby updates the gains of the variable gain amplifiers 430 to 43n. The gains of these variable gain amplifiers correspond to the filter coefficient of the adaptive filter unit 35a. Further, the adaptive coefficient update unit 41 updates the filter coefficient based on a filter control signal SCcnt output by the adaptive filter control unit 35c and thereby increases the convergence speed until the residual signal value reaches a predetermined value.

Next, an operation of the noise elimination device 1 according to the first exemplary embodiment is explained. The operation of the noise elimination device 1 can be divided into two processes, i.e., a siren sound detection process performed by the noise detection unit 20 and a siren sound elimination process performed by the noise suppression unit 30. Therefore, these two processes are separately explained hereinafter.

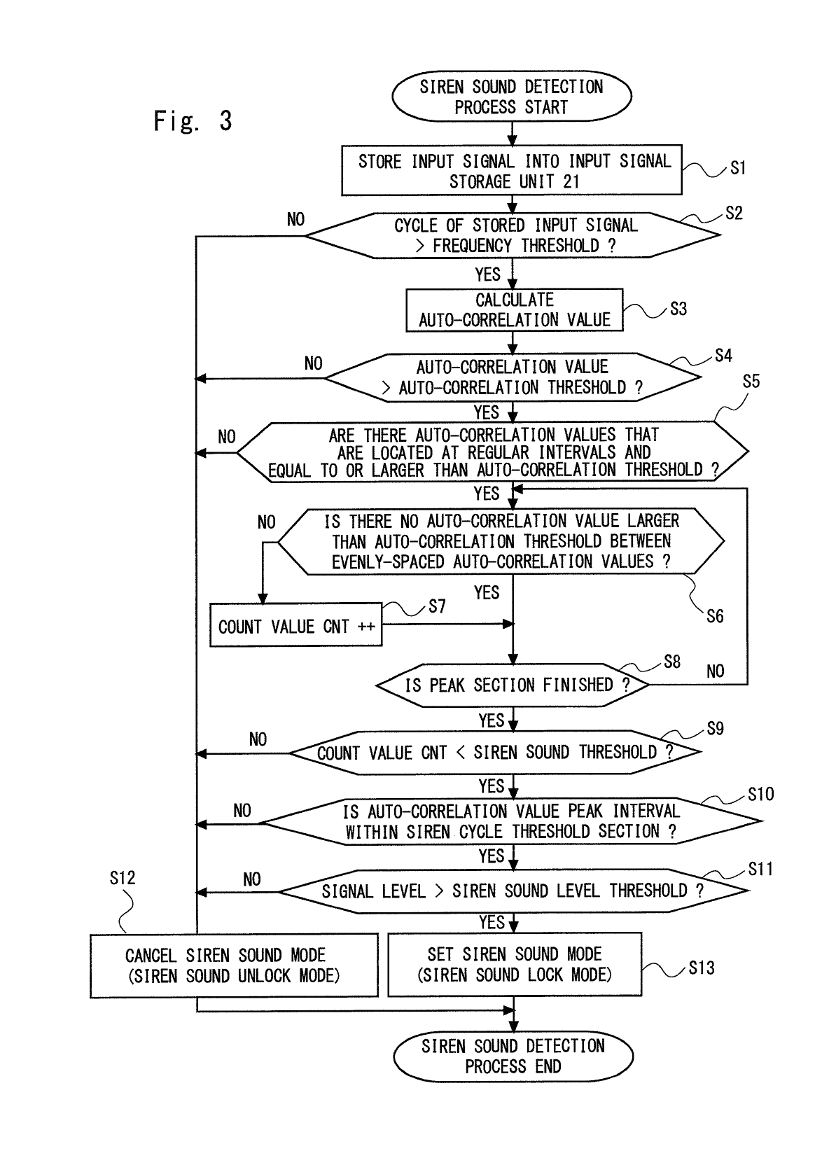

FIG. 3 is a flowchart of a siren sound detection process performed by the noise elimination device according to the first exemplary embodiment. The flowchart shown in FIG. 3 shows a series of processes performed when one input signal is input. In the noise detection unit 20, the series of processes shown in FIG. 3 is performed every time an input signal is input.

As shown in FIG. 3, every time an input signal is input, the noise elimination device 1 stores the input signal in the input signal storage unit 21 (step S1). Then, upon storing the input signal in the input signal storage unit 21, the auto-correlation value calculation unit 22a determines whether or not the number of cycles of the input signal stored in the input signal storage unit 21 is larger than a cycle number threshold (step S2). This cycle number threshold indicates a time width necessary for obtaining the cyclic nature of a siren sound. For example, one cycle of a siren sound whose frequency change over time is large is 80 msec to 300 msec. Therefore, when the one cycle of a siren sound is defined as being from 80 msec to 300 msec, the cycle number threshold is set to a value at least two times as large as this cycle. The cycle number threshold is not limited to the value two times as large as one cycle of the siren sound. That is, the cycle number threshold may be set to any integer that is an integral multiple of one cycle of the siren sound.

In the step S2, when it is determined that input signals larger than the cycle number threshold have not been accumulated yet in the input signal storage unit 21, the siren sound determination unit 23 sets a siren sound mode signal to a siren sound unlock mode indicating that no siren sound has been detected (step S12). Then, after the process in the step S12, the noise detection unit 20 temporarily terminates the siren sound detection process.

On the other hand, when it is determined that input signals larger than the cycle number threshold have been accumulated in the input signal storage unit 21 in the step S2, the auto-correlation value calculation unit 22a calculates an auto-correlation value(s) based on the above-shown Expression (1) or the like (step S3). Then, the correlation value analysis unit 22b analyzes the auto-correlation value(s) and thereby determines whether or not there is an auto-correlation value larger than an auto-correlation threshold (step S4). When it is determined that there is no auto-correlation value larger than the auto-correlation threshold in this step S4, the siren sound determination unit 23 performs the process in the step S12 and the noise detection unit 20 temporarily terminates the siren sound detection process. On the other hand, when it is determined that there is an auto-correlation value larger than the auto-correlation threshold in this step S4, the correlation value analysis unit 22b outputs the positions and the intervals of peaks of the auto-correlation value to the siren sound determination unit 23 and the siren sound determination unit 23 determines the presence/absence of a siren sound.

As a step S5 subsequent to the step S4, the siren sound determination unit 23 determines whether or not there are auto-correlation values (peaks of auto-correlation values) that are larger than the auto-correlation threshold and located at regular intervals. When it is determined that the peaks of the auto-correlation value are not located at regular intervals in the step S5, the siren sound determination unit 23 performs the process in the step S12 and the noise detection unit 20 temporarily terminates the siren sound detection process. On the other hand, when it is determined that the peaks of the auto-correlation value are located at regular intervals in the step S5, the siren sound determination unit 23 determines whether or not there is a peak of other auto-correlation values between those evenly-spaced peaks (step S6).

When it is determined that there is a peak of other auto-correlation values between the evenly-spaced peaks in this step S6 (N-branch at step S6), the siren sound determination unit 23 increments a count value CNT by one (step S7) and performs a process in a step S8. On the other hand, when it is determined that there is no peak of other auto-correlation values between the evenly-spaced peaks in this step S6 (Y-branch at step S6), the siren sound determination unit 23 performs the process in the step S8 without incrementing the count value CNT.

In the step S8, the siren sound determination unit 23 determines whether or not the checking of all the other auto-correlation values between the evenly-spaced peaks of the auto-correlation value has been completed (step S8). That is, the siren sound determination unit 23 repeats the process in the step S6 until the checking of all the other auto-correlation values between the evenly-spaced peaks of the auto-correlation value has been completed. Then, after completing the checking of all the other auto-correlation values between the evenly-spaced peaks of the auto-correlation value, the siren sound determination unit 23 performs a process in the step S9.

In the step S9, it is determined whether or not the count value CNT is smaller than a siren sound threshold. The count value CNT indicates the number of the other auto-correlation values that have a large peak between the evenly-spaced peaks of the auto-correlation value. Therefore, in the first exemplary embodiment, a value that is determined by taking account of factors other than the siren sound that have a possibility of causing a high correlation value (e.g., an integer around 1 to 3) is set as the siren sound threshold. By comparing the count value CNT with such a siren sound threshold, it is possible to prevent a false determination that would otherwise be caused by a voice that is not a siren sound but happens to cause a high correlation value.

When the count value CNT is determined to be equal to or larger than the siren sound threshold in a step S9, the siren sound determination unit 23 performs the process in the step S12 and the noise detection unit 20 temporarily terminates the siren sound detection process. On the other hand, when the count value CNT is determined to be smaller than the siren sound threshold in the step S9, the siren sound determination unit 23 performs a process in a step S10. In the step S10, it is determined whether or not the intervals of the peaks of the auto-correlation values are included within a siren cycle threshold section. When the intervals of the peaks of the auto-correlation values are longer or shorter than the possible siren sound cycle range, the possibility that a siren sound is mixed in the input signal is small even when the peaks of the auto-correlation values are located at regular intervals. Therefore, by setting a possible siren sound time length range as a siren cycle threshold in advance, it is possible to prevent a false determination in which it is mistakenly determined that a siren sound is mixed in the input signal due to peaks of an auto-correlation value that are caused by a factor other than the siren sound but happen to be located at regular intervals. Note that the frequency change cycles of siren sounds are limited to their specific regions. Therefore, it is possible to configure the noise elimination device so that the siren cycle threshold can be set at the time of the shipment thereof or can be set by a user before the user uses the noise elimination device.

When it is determined that the intervals of the peaks of the auto-correlation values are not within the siren cycle threshold section in the step S10, the siren sound determination unit 23 performs the process in the step S12 and the noise detection unit 20 temporarily terminates the siren sound detection process. On the other hand, when it is determined that the intervals of the peaks of the auto-correlation values are within the siren cycle threshold section in the step S10, the siren sound determination unit 23 determines whether or not the signal level of the input signal is higher than a siren sound level threshold (step S11). The signal level of a siren sound is higher than those of background noises. Therefore, if the signal level is low, the detected peaks are probably not caused by a siren sound even when the conditions up to the step S10 are all met.

When it is determined that the signal level is lower than the siren sound level threshold In the step S11, the siren sound determination unit 23 performs the process in the step S12 and the noise detection unit 20 temporarily terminates the siren sound detection process. On the other hand, when it is determined that the signal level is higher than the siren sound level threshold in the step S11, the siren sound determination unit 23 changes the siren sound mode signal to a siren sound lock mode (step S13) and the noise detection unit 20 temporarily terminates the siren sound detection process.

FIGS. 4 to 7 show examples of changes of auto-correlation values over time and the above-described processes (in particular, steps S5 and S6) are explained hereinafter in a more detailed manner with reference to the figures. An example shown in FIG. 4 shows changes of an auto-correlation value of an input signal including only a siren sound over time. As shown in FIG. 4, when only the siren sound is input as an input signal, intervals t1 and t2 between peaks of the auto-correlation value are equal to each other.

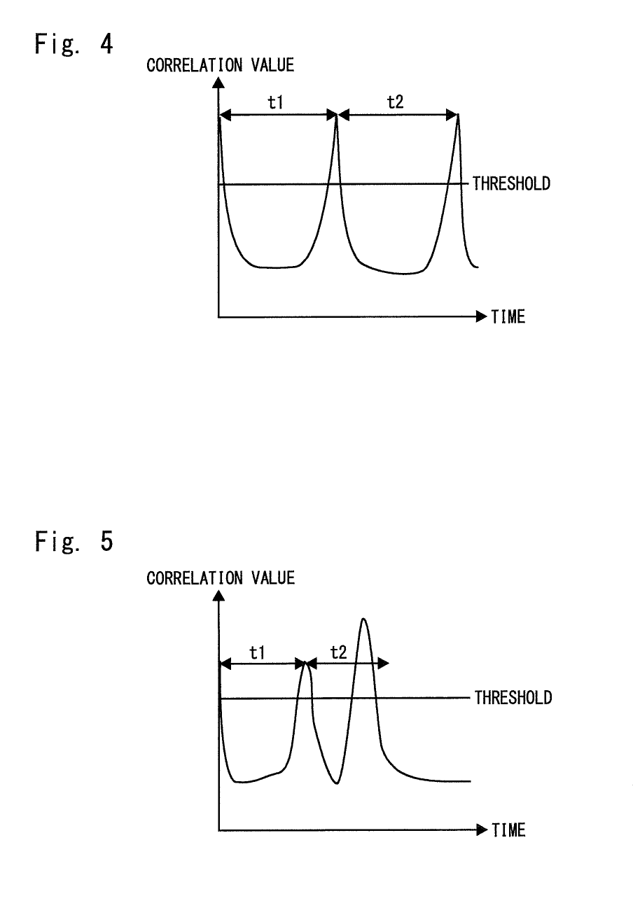

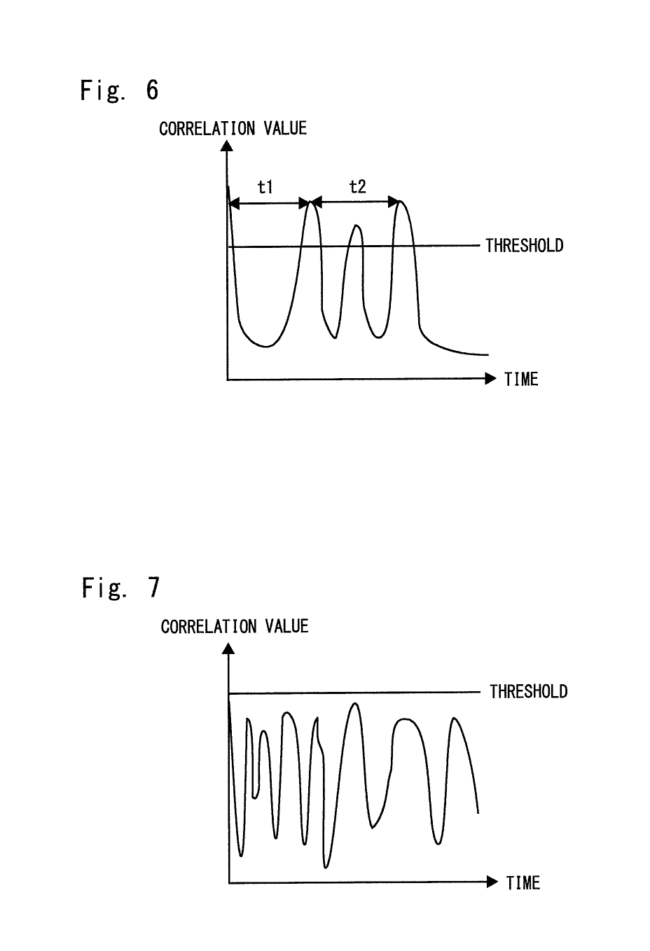

An example shown in FIG. 5 shows changes of an auto-correlation value of an input signal including only a voice signal over time. Further, an example shown in FIG. 6 shows another example of changes of an auto-correlation value of an input signal including only a voice signal over time. As shown in FIGS. 5 and 6, when only the voice signal is included in an input signal, the intervals between peaks are not equal to each other even if peaks of an auto-correlation value occur. Alternatively, even if the intervals happen to be equal to each other, a peak of other auto-correlation values occurs between the evenly-spaced peaks of the auto-correlation value.

An example shown in FIG. 7 shows changes of an auto-correlation value of an input signal including only a background noise over time. In this case, no auto-correlation value is equal to or higher than the auto-correlation threshold as shown in FIG. 7. That is, no peak of an auto-correlation value occurs.

According to the flowchart shown in FIG. 3, no siren sound is detected in the examples shown in FIGS. 5 to 7, in which no siren sound is mixed in the input signal. That is, a siren sound is detected only in the case shown in FIG. 4, in which a siren sound is included in the input signal.

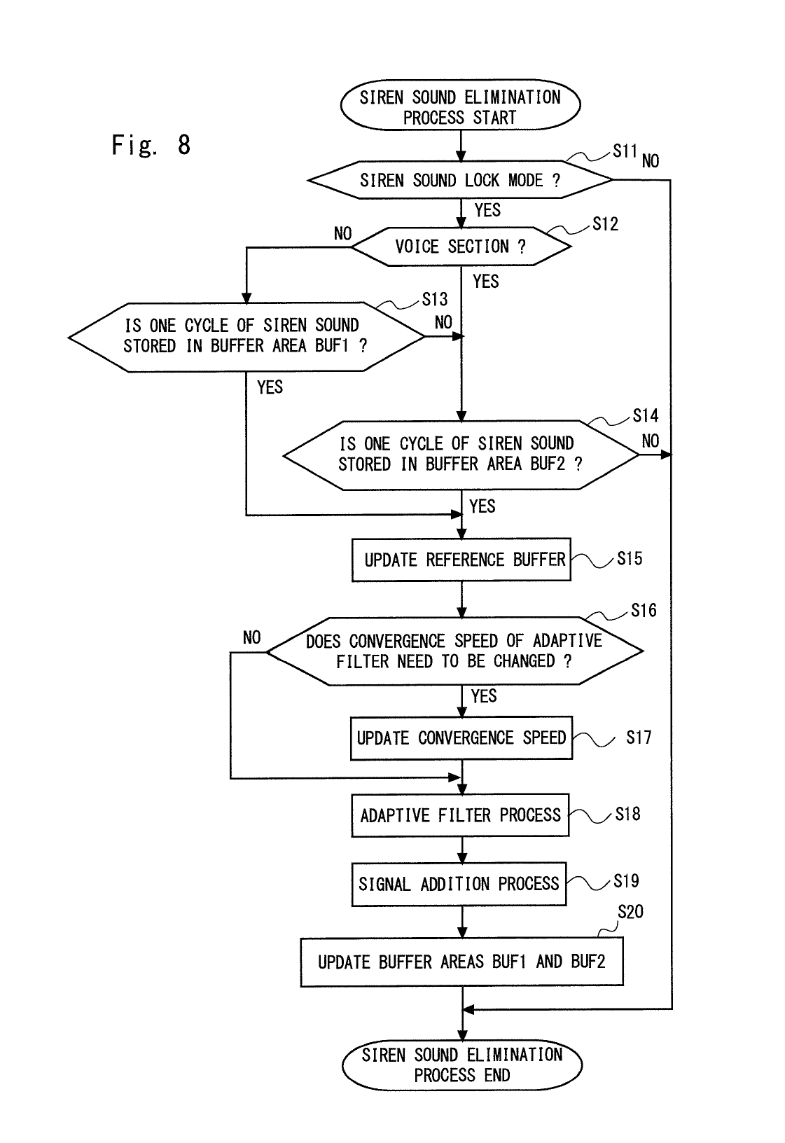

Next, a siren sound elimination process performed by the noise elimination device 1 according to the first exemplary embodiment explained. Therefore, FIG. 8 shows a flowchart of a noise elimination process performed by the noise elimination device 1 according to the first exemplary embodiment. Note that in the noise elimination device 1, the siren sound elimination process in accordance with the flowchart shown in FIG. 8 is performed every time an input signal is input.

As shown in FIG. 8, when the siren sound mode is a siren sound lock mode, the noise suppression unit 30 performs a siren sound elimination process (step S11). In the siren sound elimination process, firstly, the voice section determination unit 33 determines whether or not the current input signal is in a voice section (step S12). In this step S12, when it is determined that the current input signal is in a non-voice section in which no voice signal component is included and information corresponding to one cycle of a siren sound is stored in the first buffer unit BUF1, the siren sound information storage unit 32 outputs noise history information stored in the first buffer unit BUF1 to the reference buffer unit 34 (Y-branch at step S13). Further, when information corresponding to one cycle of a siren sound is not stored in the first buffer unit BUF1 in the step S13 (N-branch at step S13) and information corresponding to one cycle of a siren sound is stored in the second buffer unit BUF2, the siren sound information storage unit 32 outputs noise history information stored in the second buffer unit BUF2 to the reference buffer unit 34 (step S14). Further, when it is determined that the current input signal is in a voice section in the step S12 and information corresponding to one cycle of a siren sound is stored in the second buffer unit BUF2, the siren sound information storage unit 32 also outputs noise history information stored in the second buffer unit BUF2 to the reference buffer unit 34 (step S14). On the other hand, when information corresponding to one cycle of a siren sound is stored neither in the first buffer unit BUF1 nor in the second buffer unit BUF2, the noise suppression unit 30 finishes the siren sound elimination process (N-branch at step S14).

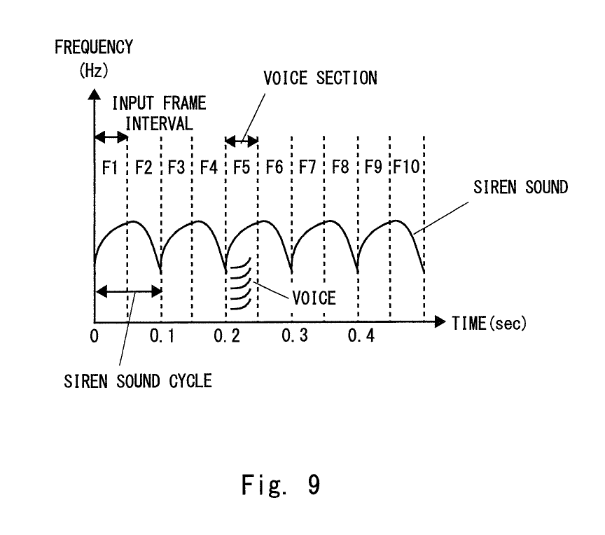

Next, the reference buffer unit 34 updates reference signal information by the noise history information output in the step S13 or S14 (step S15). The update process of the reference signal is explained hereinafter in a more detailed manner. Therefore, FIG. 9 shows a graph for explaining an example of an input signal input to the noise elimination device according to the first exemplary embodiment, and the update process of the reference signal is explained in detail with reference to FIG. 9.

An example shown in FIG. 9 shows changes of the frequency of an input signal. FIG. 9 shows an example in which input signals F1 to F10, which have been converted into frames, are successively input. Further, in the example shown in FIG. 9, a voice signal component is included in the input signal F5. Further, in FIG. 9, the cycle of the siren sound has such a length that two frames corresponds to one cycle.

When information corresponding to one cycle of a siren sound in a non-voice section is stored in the first buffer unit BUF1, the signal is taken out from the first buffer unit BUF1 and stored as the reference signal in the reference buffer. For example, when the input signal F3 is input, the input signals F1 and F2 are already stored in the first buffer unit BUF1. In this case, the input signal F1, which is in synchronization with the input signal F3 (the frame cycle is shifted by one cycle), is input to the reference buffer. Similarly, when the input signal F4 is input, the input signal F2 is input to the reference buffer.

When a voice signal is included in the frame to be analyzed or when information corresponding to one cycle of a siren sound is not stored in the first buffer unit BUF1, the signal is taken out from the second buffer unit BUF2 and stored as the reference signal in the reference buffer. When the input signal F5, in which a voice signal is included, is input, the input signal F3 is input to the reference buffer because the input signals F3 and F4 are already stored in the second buffer unit BUF2. Further, when input signal F6 is input, the input signal F4 is input to the reference buffer. In this way, if a position of which the frame cycle is shifted from the frame to be analyzed by one cycle is stored in the second buffer unit BUF2, the position of which the frame cycle is shifted by one cycle can be continuously input to the reference buffer. However, when the input signal F7 is input, no signal corresponding to the input signal F7 is stored because the input signal F5 whose frame cycle is shifted from the input signal F7 by one cycle includes the voice signal. Therefore, the input signal F3, which is stored in the second buffer unit BUF2 and is in synchronization with the input signal F7, is input to the reference buffer again. As described above, when information corresponding to one cycle of a siren sound is not stored in the first buffer unit BUF1 due to the influence of the voice signal, the signal stored in the second buffer unit BUF2, in which information corresponding to one cycle of a siren sound in the past is stored, is taken out and stored as a reference signal in the reference buffer by using the second buffer unit BUF2 in a looped fashion. Since a high-speed siren sound has a cyclic nature, the adverse effect on the adaptive filter that is caused by using the siren sound in the past as the reference signal is small. Further, when the input signal F8 is input, information corresponding to one cycle of a siren sound in a non-voice section (input signal F6 and F7) is already stored in the first buffer unit BUF1. Therefore, the buffer units are switched again so that the input signal F6 is output from the first buffer unit BUF1 to the reference buffer.

As explained above, it is possible to use appropriate signals that are in synchronization with the input signal as the reference signal by switching the buffer units having input signals by which the reference buffer updated. However, there is a problem. Discontinuity could occur in connected parts between reference signals when the reference signal is output by using the second buffer unit BUF2 in the looped fashion or when the buffer unit that outputs the reference signal is switched from the second buffer unit BUF2 to the first buffer unit BUF1. To solve this phenomenon, when a signal obtained by using the second buffer unit BUF2 in the looped fashion is used as the reference signal or when the buffer unit that outputs the reference signal is switched from the second buffer unit BUF2 to the first buffer unit BUF1, the noise suppression unit 30 performs the below-described process in a step S16.

Next, the noise suppression unit 30 determines whether or not it is necessary to change the convergence speed of the adaptive filter unit 35a based on continuity information output by the siren sound information storage unit 32 or a residual signal value output by the adder 35b (step S16). In this step S16, when it is determined that the continuity information is in a disenabled state indicating that the reference signal is discontinuous or that a residual signal has changed to a value lower than a predetermined value, the adaptive filter control unit 35c updates the convergence speed (step S17). On the other hand, when it is determined that the continuity information is in an enabled state indicating that the reference signal keeps the continuity or that the residual signal keeps a value equal to or higher than the predetermined value, the adaptive filter control unit 35c does not perform the convergence speed update process in the step S17.

Next, the noise suppression unit 30 performs an adaptive filter process in the noise filter 35 and thereby generates a suppression signal based on the reference signal (step S18). Then, the noise suppression unit 30 adds the suppression signal and the current input signal, and outputs the resultant signal as an output signal So (step S19). After that the noise suppression unit 30 updates the first and second buffer units BUF1 and BUF2 of the siren sound information storage unit 32 (step S20) and finishes the siren sound elimination process.

The buffer unit update process in the step S20 is explained hereinafter in detail. The following explanation is given by referring to FIG. 9 again.

When a siren sound is included in the input signal, the siren sound information storage unit 32 stores information corresponding to one cycle of that siren sound (e.g., noise history information). The stored siren sound needs to be obtained by accumulating input signals in a non-voice section(s). The first buffer unit BUF1 secures a siren sound that has been input in the newest non-voice section. Further, the second buffer unit BUF2 continuously secures information corresponding to one cycle of a siren sound in a non-voice section. When the voice section signal changes to an enabled state (a state where an input signal including a voice signal component is detected), the noise history information stored in the first buffer unit BUF1 is initialized. When information corresponding to one cycle of a siren sound in a non-voice section has been stored in the first buffer unit BUF1, the siren sound information stored in the first buffer unit BUF1 is transferred to the second buffer unit BUF2.

More specifically, when an input signal F1 is input, the input signal F1 is stored in the first buffer unit BUF1. Next, when an input signal F2 is input, the input signal F2 is added in the first buffer unit BUF1. At this point, since information corresponding to one cycle of a siren sound has been stored in the first buffer unit BUF1, the information corresponding to one cycle of the siren sound stored in the first buffer unit BUF1 is transferred to the second buffer unit BUF2. That is, the information of the input signals F1 and F2 are stored in the second buffer unit BUF2 as noise history information. Whether information corresponding to one cycle of a siren sound has been stored in the first buffer unit BUF1 or not is determined based on the cycle information of the siren sound detected by the noise detection unit 20.

Next, when an input signal F3 is input, the siren sound information storage unit 32 deletes the old input signal F1 stored in the first buffer unit BUF1 and adds the newly input input signal F3 in the first buffer unit BUF1. As a result, since information corresponding to one cycle of a siren sound has been stored in the first buffer unit BUF1 again, the information corresponding to one cycle of the siren sound is written into the second buffer unit BUF2. As a result, the information of the input signals F2 and F3 are stored in the second buffer unit BUF2 as noise history information. Subsequently, when an input signal F4 is input, the information of the input signals F3 and F4 are stored in the first and second buffer units BUF1 and BUF2 in a similar manner to that for the input signal F3.

Next, when an input signal F5 including a voice signal is input, the input signal F5 is not stored in the first buffer unit BUF1 and the first buffer unit BUF1 is initialized. This is because the signal stored in the first buffer unit BUF1 needs to be a signal in a non-voice section. As a result, no information corresponding to one cycle of a siren sound is stored in the first buffer unit BUF1. Therefore, no update process is performed for the second buffer unit BUF2 based on the input signal F5.

Next, when an input signal F6 is input, the input signal F6 is stored in the first buffer unit BUF1. At this point, since information corresponding to one cycle of a siren sound has not stored yet in the first buffer unit BUF1, the second buffer unit BUF2 is not updated. As a result, at the point when the input signal F6 is input, the second buffer unit BUF2 maintains the state where the input signals F3 and F4 are stored.

Next, when an input signal F7 is input, the input signal F7 is stored (i.e., added) in the first buffer unit BUF1. As a result, since information corresponding to one cycle of a siren sound has been stored in the first buffer unit BUF1, the information corresponding to one cycle of the siren sound (input signals F6 and F7) is written into the second buffer unit BUF2.

In this manner, the update and the storage for each buffer unit are selected based on a voice signal detection signal output from the voice section determination unit 33. As for the format of the buffers, they may be updated from the head to the tail in a time series fashion at each update process. Alternatively, old data may be updated by new data by using a ring buffer in which the head position in terms of the time is separately memorized.

As explained above, in the noise elimination device 1 according to the first exemplary embodiment, a reference signal used to generate a suppression signal is generated from an input signal(s) including no voice signal component obtained from a preceding input signal(s) that has been input before the current input signal. As a result, the noise elimination device 1 according to the first exemplary embodiment does not need to hold any information for the reference signal in advance and is able to perform a highly accurate siren sound elimination process according to the characteristic of the periodic noise mixed in the input signal without depending on the cyclic nature of the periodic noise.

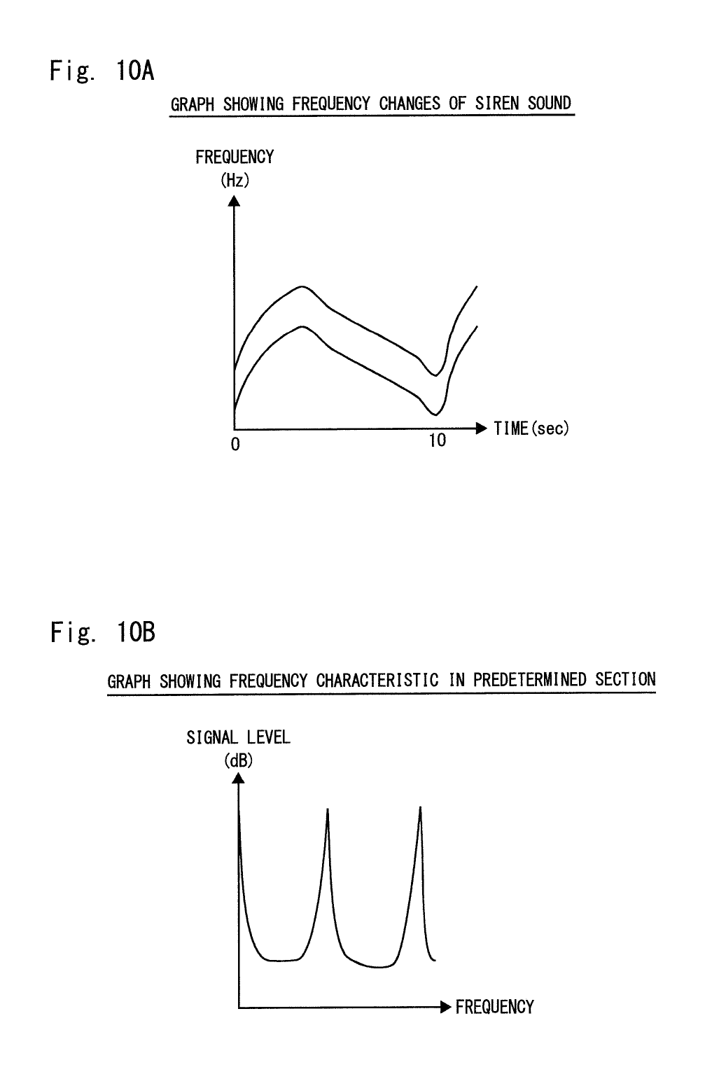

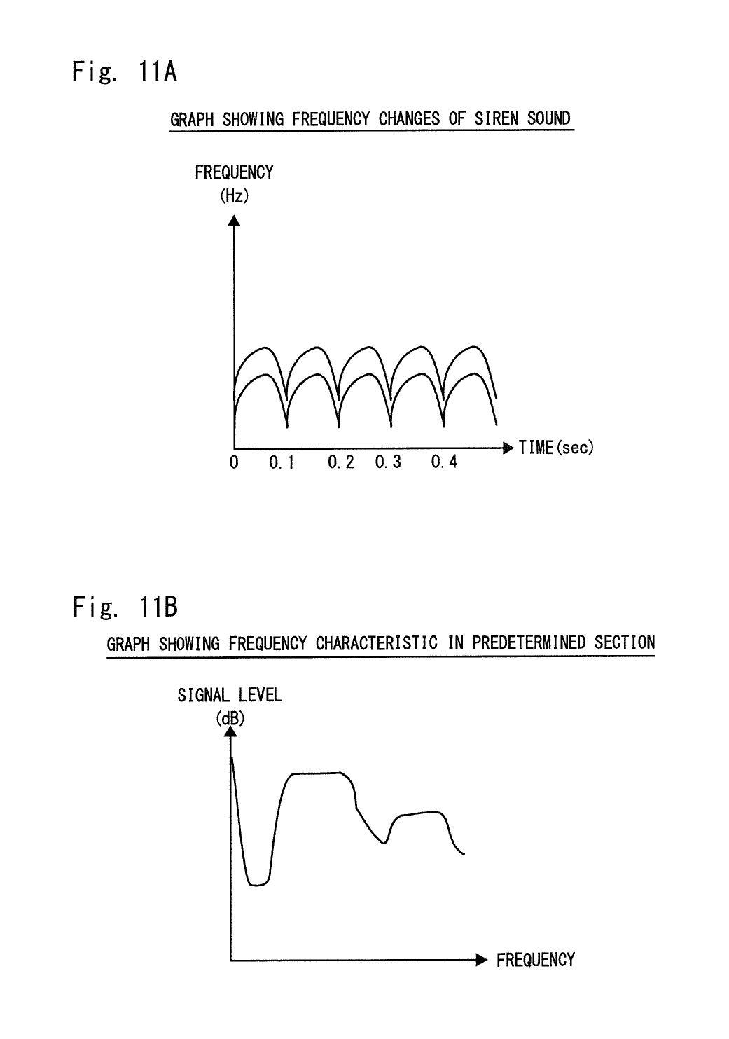

Further, the noise elimination device 1 according to the first exemplary embodiment generates an auto-correlation value between the current input signal and a preceding input signal(s) input in the past based on the current input signal and the preceding input signal(s), and detects a siren sound by paying attention to the cyclic nature of peaks of the auto-correlation value. In this way, the noise elimination device 1 according to the first exemplary embodiment can detect a siren sound with high direction accuracy. This advantageous effect is explained hereinafter with reference to graphs showing frequency changes of input signals over time and signal level changes thereof over frequencies shown in FIGS. 10 and 11.

An example shown in FIGS. 10A and 10B show an example of an input signal whose frequency changes over time is relatively gentle. An example shown in FIGS. 11A and 11B show an example of an input signal whose frequency changes over time is relatively sharp. As shown in FIGS. 10A and 10B, when the frequency changes over time are relatively gentle, the dependence of the signal level on the frequency is high. Therefore, it is relatively easy to determine the presence/absence of a periodic noise based on the signal level by converting the time-domain input signal into a frequency-domain signal. In contrast to this, as shown in FIGS. 11A and 11B, when the frequency changes over time are relatively sharp, the dependence of the signal level on the frequency is low. Therefore, it is relatively difficult to determine the presence/absence of a periodic noise based on the signal level even when the time-domain input signal is converted into a frequency-domain signal. However, since the auto-correlation value based on the time-domain signal uses a correlation value between a preceding input signal(s) input in the past and the current input signal for the determination of the presence/absence of a periodic noise, the above-described problem does not occur.

Further, in prior art, in communication in mobile communication, background noises and noises whose frequency characteristic and power vary over time such as a high-speed changing type siren sound have adverse effects on the voices, thus making hearing the voices very difficult. In the prior-art spectral subtraction method, the noise/elimination method in a frequency range, and the SPAC method, there is a limit on the improvement of the performance due to the problems such as a frequency resolution, a process delay, and signal discontinuity. In contrast to this, the noise elimination device 1 according to the first exemplary embodiment can accurately determine peak positions of an auto-correlation result and the presence/absence of a high-speed changing type siren sound (having a short cycle of frequency changes) from a peak section(s). Further, information corresponding to one cycle of a siren sound in a non-voice section obtained from the cycle of a detected siren sound and the information of voice section determination can be appropriately managed in the buffers of the voice section determination unit 33.

Further, the noise elimination device 1 according to the first exemplary embodiment, in which a reference signal is generated from an input signal corresponding to one cycle of a siren sound obtained in a non-voice section, includes the second buffer unit BUF2 that continuously holds an input signal corresponding to one cycle of a siren sound obtained in a non-voice section in addition to the first buffer unit BUF1 that stores the newest input signal. As a result, even when an input signal including a voice signal component is input, a reference signal can be generated from an input signal corresponding to one cycle of a siren sound obtained in a non-voice section. That is, since the noise elimination device 1 can always generates a reference signal including no voice signal component based on an input signal(s) input in the past, the noise elimination device 1 can ensure a high noise elimination capability.

Further, when the buffer that outputs noise history information serving as the reference signal is switched or when noise history information stored in the buffer is used in a looped fashion, there is a possibility that the continuity of the reference signal cannot be kept (a discontinuous joint could occurs between buffers) and the siren sound suppression effect is lowered. However, when discontinuity occurs in the reference signal, the noise elimination device 1 according to the first exemplary embodiment temporarily increases the convergence speed of the adaptive filter and thereby restores the suppression effect. Further, to reduce the adverse effect on the voice, the converging speed is reduced in accordance with a predetermined time interval. As a result, the noise elimination device 1 according to the first exemplary embodiment can ensure the overall voice quality. With the above-described processes, it is possible to minimize the deterioration of a voice signal caused by a siren sound whose cycle of frequency changes over time is short and thereby to expect that the communication quality is improved.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A noise elimination device comprising:
a periodic noise information storage unit configured to accumulates an input signal including a periodic noise, and thereby stores noise history information which includes at least one cycle of the periodic noise in a non-voice section in which a voice signal component is equal to or lower than a predetermined voice threshold level, wherein the voice signal component is being a main component of an output signal; and
a noise filter that generates a suppression signal in which the periodic noise included in the input signal is reversed by using the noise history information as a reference signal, and generates the output signal in which the periodic noise included in the input signal is suppressed by using the suppression signal.

2. The noise elimination device according to claim 1, further comprising a voice section determination unit configured to puts a voice section signal into an enabled state when the voice signal component included in the input signal is higher than the predetermined voice threshold level, wherein
the periodic noise information storage unit further comprises:
a first buffer unit configured to successively stores the input signal and thereby accumulates the noise history information; and
a second buffer unit configured to stores noise history information having a length corresponding to one cycle of the periodic noise in the non-voice section from the noise history information stored in the first buffer unit, and
in response to a change of the voice section signal into the enabled state, the periodic noise information storage unit initializes the noise history information stored in the first buffer unit and outputs the noise history information stored in the second buffer unit.

3. The noise elimination device according to claim 2, wherein when the noise history information corresponding to one cycle of the periodic noise has been accumulated in the first buffer unit, the periodic noise information storage unit updates the noise history information stored in the second buffer unit by the noise history information stored in the first buffer unit.

4. The noise elimination device according to claim 1, wherein
the noise filter comprises:
an adaptive filter unit configured to generates the suppression signal based on the reference signal; and
an adder that outputs a residual component between the suppression signal and the input signal as the output signal,
wherein the adaptive filter unit shapes a waveform of the suppression signal based on the residual component.

5. The noise elimination device according to claim 4, wherein the noise filter further comprises an adaptive filter control unit configured to outputs a filter control signal for accelerating a convergence speed of the adaptive filter unit in response to a state of the reference signal is being a temporally discontinuous state.

6. The noise elimination device according to claim 1, further comprising:
a noise detection unit configured to outputs a periodic noise detection signal including cycle information of the periodic noise, upon detecting that the periodic noise is included in a current input signal based on a correlation between the current input signal and a preceding input signal, wherein the preceding input signal is being input before the current input signal; and
a reference information control configured to instructs a range of noise history information to be output by the periodic noise information storage unit based on the cycle information of the periodic noise.

7. The noise elimination device according to claim 6, wherein the noise detection unit comprises:
an input signal storage unit configured to accumulates the current input signal and thereby stores the preceding input signal;
an auto-correlation unit configured to calculates an auto-correlation value between the current input signal and the preceding input signal and analyzes cycle information of the auto-correlation value larger than a predetermined auto-correlation threshold; and
a periodic noise determination unit configured to determines whether or not the periodic noise is included in the current input signal based on the cycle information, and when the periodic noise is included in the current input signal, outputs the cycle information to the reference information control unit.

8. A noise elimination method in a noise elimination device that suppresses a periodic noise included in an input signal and outputs an output signal, the noise elimination method comprising:
accumulating the input signal, and thereby storing noise history information which includes at least one cycle of the periodic noise in a non-voice section in which a voice signal component is equal to or lower than a predetermined voice threshold level, wherein the voice signal component is being a main component of an output signal; and
generating a suppression signal in which the periodic noise included in the input signal is reversed by using the noise history information as a reference signal, and generating the output signal by suppressing the periodic noise included in the input signal by using the suppression signal.

9. A non-transitory computer readable medium storing a noise elimination program executed by an arithmetic unit in a noise elimination device, the noise elimination device comprising the arithmetic unit and a storage unit and being configured to suppress a periodic noise included in an input signal and output an output signal, the noise elimination program being adapted for causing a computer to execute:
a periodic noise information storing step of accumulating the input signal including the periodic noise, and thereby storing noise history information which includes at least one cycle of the periodic noise in a non-voice section in which a voice signal component is equal to or lower than a predetermined voice threshold level, wherein the voice signal component is being a main component of the output signal; and
a noise filter step of generating a suppression signal in which the periodic noise included in the input signal is reversed by using the noise history information as a reference signal, and generating the output signal in which the periodic noise included in the input signal is suppressed by using the suppression signal.
